(19) United States
(12) Patent Application Publication
(10) Pub. No.: US 2013/0206732 A1
(43) Pub. Date: Aug. 15, 2013

(54) ELECTRIC DISCHARGE MACHINING DEVICE

(71) Applicants: Masaaki Nishio, Chiyoda-ku (JP); Hidetaka Katougi, Chiyoda-ku (JP)

(72) Inventors: Masaaki Nishio, Chiyoda-ku (JP); Hidetaka Katougi, Chiyoda-ku (JP)

(73) Assignee: MITSUBISHI ELECTRIC CORPORATION, Chiyoda-ku, Tokyo (JP)

(21) Appl. No.: 13/704,271

(22) PCT Filed: Feb. 15, 2012
(86) PCT No.: PCT/JP12/53510

§ 371 Date: Dec. 14, 2012

(51) Int. Cl. B23H 1/02

(52) U.S. Cl. CPC B23H 1/02
USPC 219/69.13

(57) ABSTRACT

An electric discharge machining unit that performs electric discharge machining by clamping a target object with a clamper of a clamping device, the electric discharge machining unit including a timer that measures a lapse of a time, which has been set by a user as a preparation time for supporting the target object after an operation of a clamping/unclamping button for clamping or unclamping is detected, and a clamper control unit that causes the clamping device to perform an operation corresponding to the detected operation at a time-out of the timer.

### FIELD

The present invention relates to an electric discharge machining device.

### BACKGROUND

Conventionally, a tool electrode or a workpiece for an electric discharge machining device is clamped by a clamping device.

Generally, in order to prevent erroneous operations when holding (clamping) or releasing (unclamping) a tool electrode to or from a clamping device, in the operations of clamping and unclamping, it is required to perform “long time pressing”, that is, to press a clamping/unclamping button for a predetermined time.

In the above configuration, the clamping device performs clamping or unclamping operations soon after “long time pressing” of the clamping/unclamping button is detected. Accordingly, when an operator manually replaces a tool electrode that has been held by the clamping device by himself, the operator needs to operate a clamping button with one hand while supporting the tool electrode with the other hand in order to prevent the unclamped tool electrode from falling down. However, there is a possibility that the operator cannot support the tool electrode and drops the tool electrode depending on the weight of the tool electrode.

Similarly, when attaching the tool electrode to the clamping device, an operator needs to operate a clamping button with one hand while supporting the tool electrode with the other hand. Accordingly, there is a possibility that the operator may not be able to hold the tool electrode at a holding position correctly, thereby failing to set the tool electrode to the clamping device completely or dropping the tool electrode.

Patent Literature 1 discloses a technology of unclamping a tool after a lapse of a predetermined time following a replacing operation of the tool.

### CITATION LIST

### Patent Literature

Patent Literature 1: Japanese Patent Application Laid-open No. 03-190642

### SUMMARY

### Technical Problem

However, the conventional technology mentioned above relates to executing control for positioning a rotating mechanism at the inside of an automatic tool replacing device with using a timer, and does not assume a case of handling a tool electrode by hand. Therefore, the conventional technology does not solve the above problems such that, when an operator manually replaces a tool electrode by himself, there is a possibility that the operator may drop the tool electrode or causes a clamping device to be held incompletely.

Although an example of holding a tool electrode by a clamping device has been described above, problems similar to those described above happen when a workpiece is held by the clamping device.

The present invention has been achieved in view of the above problems, and an object of the present invention is to provide an electric discharge machining device that allows an operator to manually replace a tool electrode or a workpiece by himself without dropping it or causing it to be held to a clamping device incompletely.

### Solution to Problem

In order to solve above-mentioned problems and achieve the object of the present invention, there is provided an electric discharge machining device that performs electric discharge machining by clamping a target object with a clamping device, the electric discharge machining device including: a timer that counts a lapse of a time, which has been set by a user as a preparation time for supporting the target object after an operation for clamping or unclamping is detected; and a clamper control unit that causes the clamping device to perform an operation corresponding to the detected operation at a time-out of the timer.

### Advantageous Effects of Invention

The electric discharge machining device according to the present invention allows an operator to support a target object with both hands while a timer counts down even when the operator cannot support the target object as it is too heavy. Accordingly, the present invention can prevent a case where an unclamped target object falls from a clamping device or the operator causes the target object to be clamped to the clamping device incompletely.

### BRIEF DESCRIPTION OF DRAWINGS

FIG. 1 depicts a configuration of an electric discharge machining device according to a first embodiment of the present invention.

FIG. 2 is a flowchart of a flow of an operation at the time of attaching and detaching a target object in the electric discharge machining device according to the first embodiment.

FIG. 3 depicts a configuration of an electric discharge machining device according to a second embodiment of the present invention.

FIG. 4 is a flowchart of a flow of an operation at the time of attaching a target object in the electric discharge machining device according to the second embodiment.

FIG. 5 depicts a configuration of an electric discharge machining device according to a third embodiment of the present invention.

FIG. 6 is a flowchart of a flow of an operation at the time of attaching a target object in the electric discharge machining device according to the third embodiment.

FIG. 7 is a flowchart of a flow of an operation at the time of detaching a target object in the electric discharge machining device according to the third embodiment.

FIG. 8 depicts a configuration of an electric discharge machining device according to a fourth embodiment of the present invention.

FIG. 9 is a flowchart of a flow of an operation at the time of detaching a target object from the electric discharge machining device according to the fourth embodiment.

FIG. 10 is a schematic diagram of an example of a change in a load applied on a main shaft.

FIG. 11 depicts a configuration of an electric discharge machining device according to a fifth embodiment of the present invention.

FIG. 12 is a flowchart of a flow of an operation at the time of attaching and detaching a target object in the electric discharge machining device according to the fifth embodiment.

### DESCRIPTION OF EMBODIMENTS

Exemplary embodiments of an electric discharge machining device according to the present invention will be explained below in detail with reference to the accompanying drawings. The present invention is not limited to the embodiments.

### First Embodiment

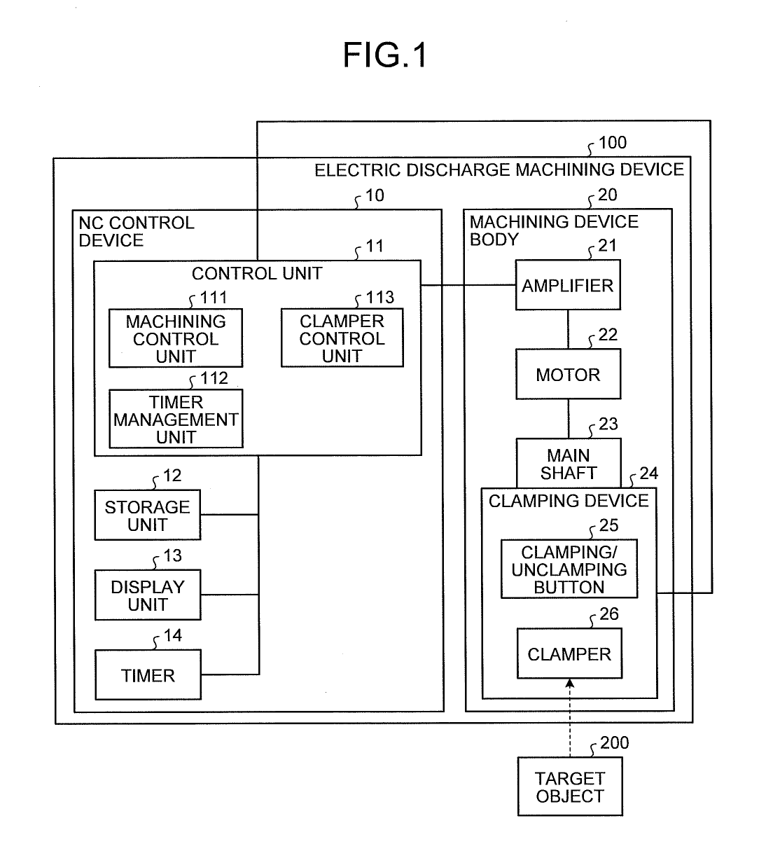

FIG. 1 depicts a configuration of an electric discharge machining device according to a first embodiment of the present invention. An electric discharge machining device 100 includes an NC control device 10 and a machining device body 20. The machining device body includes an amplifier(AMP) 21, a motor 22 and a main shaft 23. The main shaft includes a clamping device for clamping a target object 200. For example, the target object 200 is a tool electrode or a workpiece. If the tool electrode is the target object 200, the workpiece is provided on a table (not shown). If the workpiece is the target object 200, a tool electrode is provided on the table (not shown). The clamping device 24 includes a clamping/unclamping button 25 for clamping and unclamping operations of the target object 200 and a clamper 26 that actually holds the target object 200. The NC control device 10 causes the machining device body 20 to perform electric discharge machining according to an NC program, and includes a control unit 11, a storage unit 12, a display unit 13, and a timer 14.

The control unit 11 includes a machining control unit 111 that causes the machining device body 20 to perform electric discharge machining by executing an NC program, a timer management unit 112 that controls setting, activating, stopping, and displaying of the timer 14, and a clamper control unit 113 that controls the clamping device 24. The storage unit 12 stores therein parameters such as a timer setting value that is set in the timer 14 by the timer management unit 112. A user sets the timer setting value in the storage unit 12 in advance as a preparation time for holding the target object 200. The display unit 13 displays information such as a timer value. The timer 14 counts a time that is set by the timer management unit 112.

The amplifier 21 outputs a drive current that corresponds to a control signal input from the machining control unit 111 to the motor 22. The motor 22 is a drive source that moves the main shaft 23, and the main shaft 23 is moved by the drive force transmitted from the motor 22.

The clamper 26 includes a tubular part into which a stick-shaped part of the target object 200 is inserted. The target object 200 is held by clamping the stick-shaped part inserted into the tubular part. When the clamping/unclamping button 25 is pressed for a time shorter than a predetermined time, an operation of the clamping/unclamping button 25 is not detected in order to prevent erroneous operations, but it is detected by the clamper control unit 113 only after the button is pressed for a long time. While the operation of the clamping/unclamping button 25 can employ any method and it does not have to be “long time pressing” as long as it is a particular operation that avoids erroneous detections, it is desirable to employ an operation that can be performed by an operator with one hand while the target object 200 is supported with the other hand.

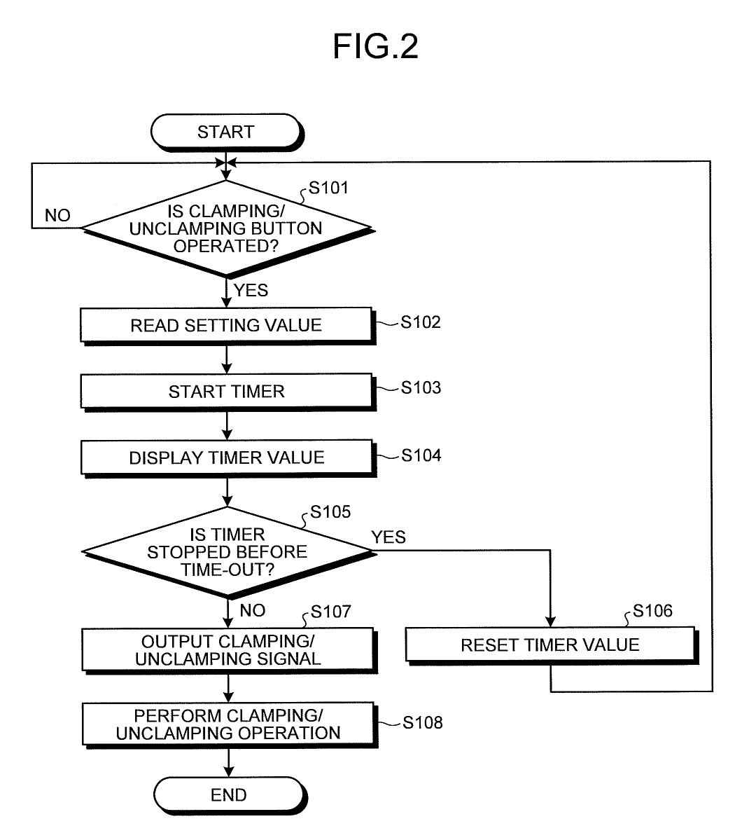

A replacing operation of the tool electrode in the electric discharge machining device according to the first embodiment is explained. FIG. 2 is a flowchart of a flow of an operation at the time of attaching and detaching a target object in the electric discharge machining device according to the first embodiment. The clamper control unit 113 monitors an operation (long time pressing) of the clamping/unclamping button 25 (Step S101). When the clamper control unit 113 detects an operation of the clamping/unclamping button 25 (YES at Step S101), the timer management unit 112 reads a setting value that is stored in the storage unit 12 (Step S102) and starts the timer 14 after setting the setting value read from the storage unit 12 in the timer 14 (Step S103). At Step S102, it is possible to set such that setting values read from the storage unit 12 can be different between a case where the clamper 26 has already held the target object 200 and a case where the clamper 26 does not clamp the target object 200. When the clamper control unit 113 does not detect any operation of the clamping/unclamping button 25 (NO at Step S101), the process returns to Step S101 and the clamper control unit 113 continues to monitor whether the clamping/unclamping button 25 is operated.

The timer management unit 112 causes the display unit 13 to display a timer value after the timer 14 is started (Step S104). An operator can stop the timer 14 before time-out after starting the timer 14. When the timer 14 is stopped (YES at Step S105), the timer 14 is reset (Step S106) and the process returns to Step S101. When time-out of the timer occurs without stopping the timer (NO at Step S105), the clamper control unit 113 outputs a clamping/unclamping signal to the clamping device (Step S107). In this process, when the clamper 26 has already clamped the target object 200, the clamper control unit 113 outputs an unclamping signal, and when the clamper 26 does not clamp the target object 200, the clamper control unit 113 outputs a clamping signal. The clamper 26 clamps or unclamps the target object 200 according to the clamping signal or the unclamping signal (Step S108).

In the present embodiment, after the clamping/unclamping button 25 is pressed for a long time, the clamper 26 clamps or unclamps the target object 200 when a predetermined time has passed. Therefore, even when an operator cannot hold the target object 200 with one hand as the object is too heavy, the operator can support the tool electrode with both hands while the timer 14 is counting down. Accordingly, it is possible to prevent a case where an unclamped target object 200 falls from the clamper 26 or the target object 200 is clamped by the clamper 26 incompletely. With this configuration, an operation of detaching and collecting a used target object 200 can be easily performed.

### Second Embodiment

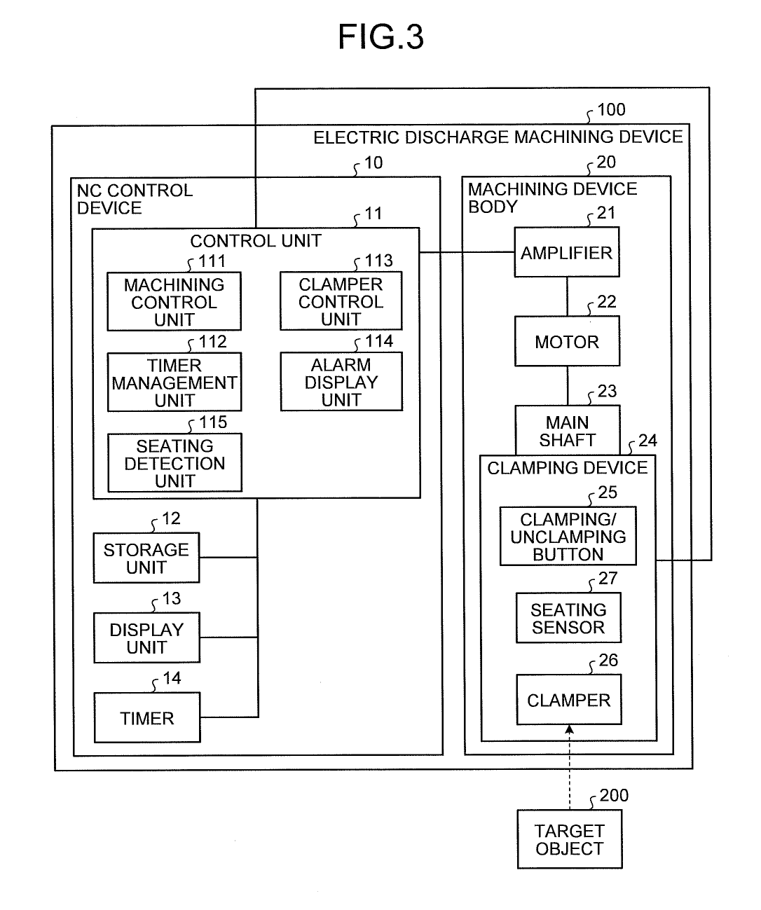

FIG. 3 depicts a configuration of an electric discharge machining device according to a second embodiment of the present invention. The electric discharge machining device according to the second embodiment differs from that according to the first embodiment in that the clamping device 24 includes a seating sensor 27 and the control unit 11 includes an alarm display unit 114 and a seating detection unit 115.

The seating sensor 27 detects whether the stick-shaped part of the target object 200 is completely inserted into (the target object 200 is seated in) the tubular part of the clamper 26. That is, the seating sensor 27 detects whether an unclamped target object 200 is arranged in a correct position of the clamper 26. The seating detection unit 115 determines whether the target object 200 is seated based on an output from the seating sensor 27. The alarm display unit 114 causes the display unit 13 to display an alarm message when the target object 200 is not seated.

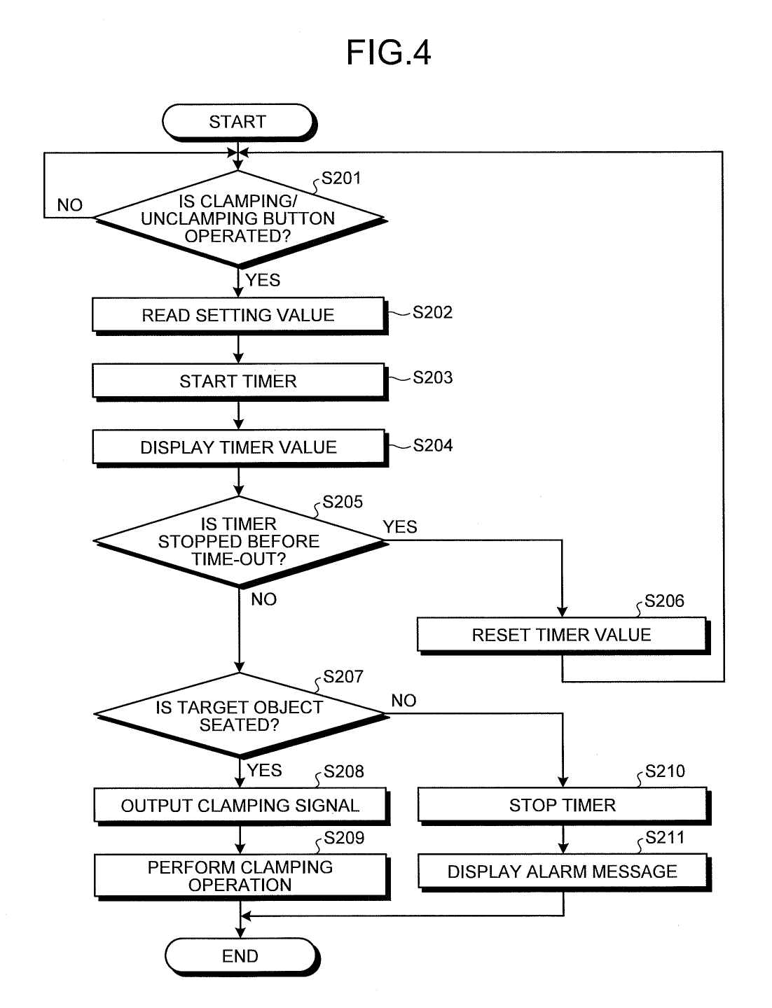

An attaching operation of a target object in the electric discharge machining device according to the present embodiment is explained. FIG. 4 is a flowchart of a flow of an operation at the time of attaching a target object in the electric discharge machining device according to the second embodiment. Operations until time-out of the timer 14 (Steps S201 to S206) are identical to those at Steps S101 to S106 of the first embodiment. When time-out of the timer 14 occurs (YES at Step S205), the seating detection unit 115 checks a detecting result of the seating sensor 27 (Step S207). When the seating sensor 27 detects that the target object 200 is seated (YES at Step S207), the clamper control unit 113 outputs a clamping signal to the clamping device 24 (Step S208). The clamper 26 clamps the target object 200 according to the clamping signal (Step S209).

On the other hand, when the seating sensor 27 does not detect that the target object 200 is seated (NO at Step S207), the timer management unit 112 stops the timer 14 (Step S210), and the alarm display unit 114 causes the display unit 13 to display an alarm message (Step S211).

Because other features of the present embodiment are identical to those of the first embodiment, redundant explanations thereof will be omitted.

In the present embodiment, when the target object 200 is not seated, the target object 200 is not clamped to the clamper 26, and because an alarm message is displayed on the display unit 13, the main shaft 23 does not move with the target object 200 while it is clamped by the clamper 26 incompletely. With this configuration, occurrences of machining defects can be prevented.

### Third Embodiment

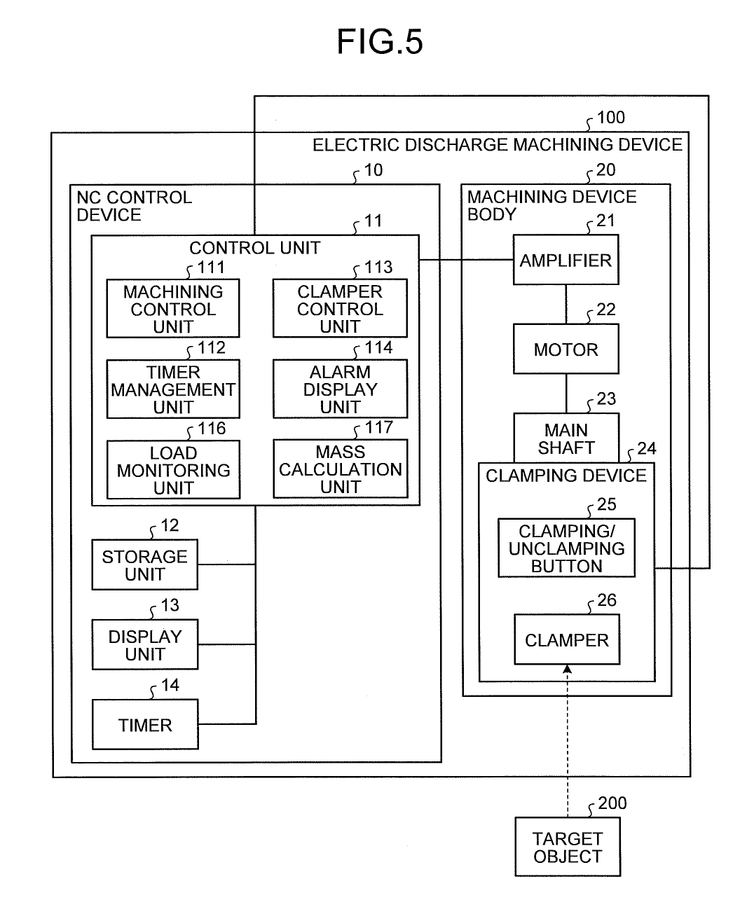

FIG. 5 depicts a configuration of an electric discharge machining device according to a third embodiment of the present invention. The electric discharge machining device 100 according to the third embodiment differs from that according to the first embodiment in that the control unit includes a load monitoring unit 116 and a mass calculation unit 117.

The load monitoring unit 116 monitors a magnitude of a load current output from the amplifier 21 to the motor 22. The mass calculation unit 117 calculates a mass of the target object 200 that is clamped to the clamper 26 based on a load current value of the motor 22. It is generally known that, when the target object 200 with a mass W is clamped by the clamper 26 and the main shaft 23 moves with a speed S, a load current value A that is output from the amplifier 21 to the motor 22 becomes proportional to “W×S”. Based on this relationship, the mass calculation unit 117 calculates the mass of the target object 200 according to the load current value of the motor 22.

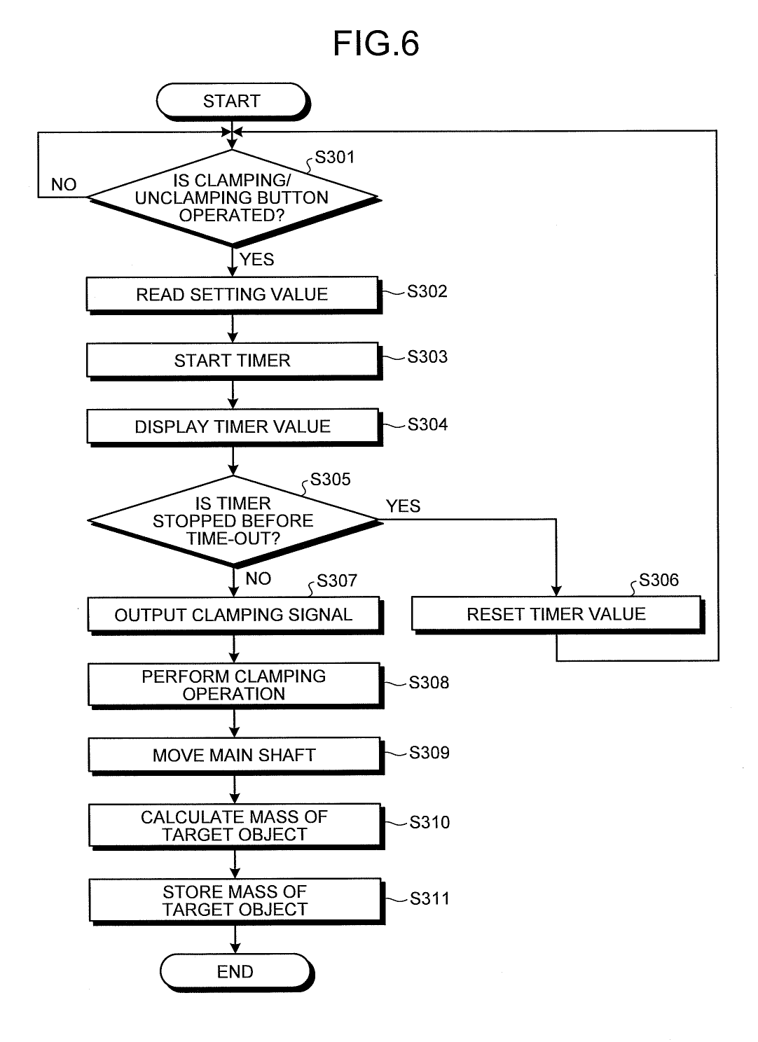

FIG. 6 is a flowchart of a flow of an operation at the time of attaching a target object in the electric discharge machining device according to the third embodiment. Operations until clamping the target object 200 to the clamper 26 (Steps S301 to S308) are identical to those at Steps S101 to S108 of the first embodiment. After the target object 200 is clamped to the clamper 26, the machining control unit 111 causes the main shaft 23 to move with a predetermined speed (Step S309). The mass calculation unit 117 calculates the mass of the target object 200 based on the load current value that is monitored at the time when the moving speed of the main shaft 23 reaches the predetermined speed (Step S310). The storage unit 12 stores therein the mass calculated by the mass calculation unit 117 (Step S311).

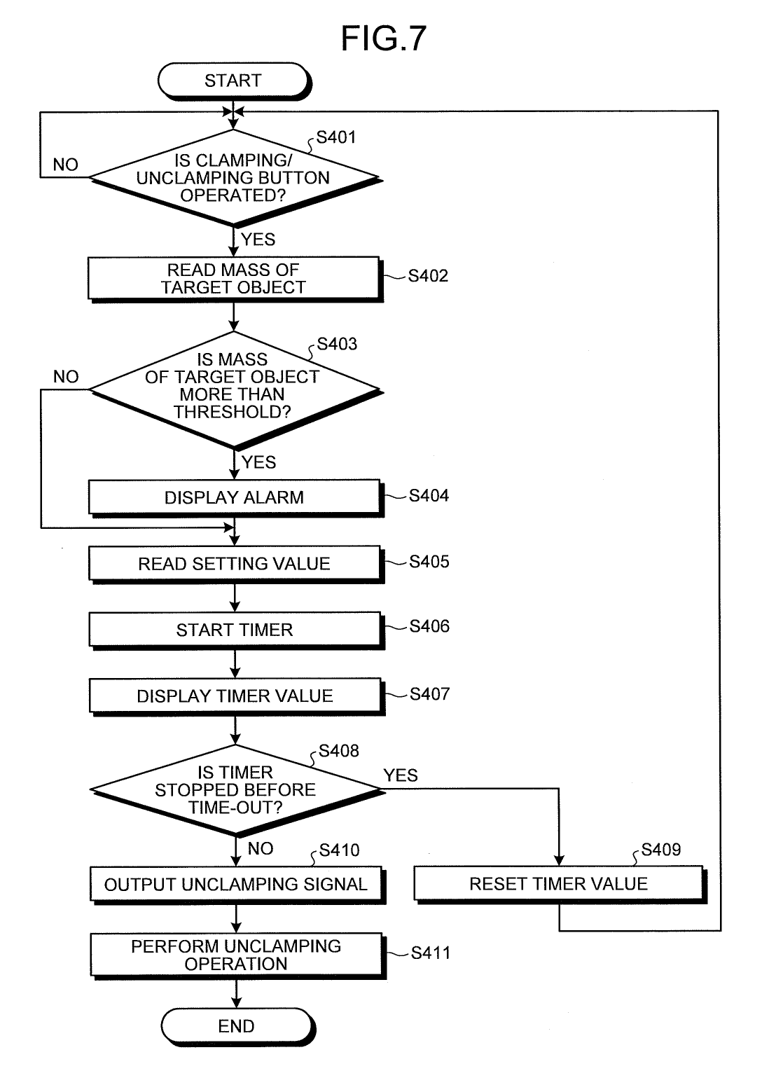

FIG. 7 is a flowchart of a flow of an operation at the time of detaching a target object in the electric discharge machining device according to the third embodiment. After the clamper control unit 113 detects that the clamping/unclamping button 25 is pressed for a long time (YES at Step S401), the alarm display unit 114 reads the mass of the target object 200 stored in the storage unit 12 (Step S402) and checks whether the mass is more than a threshold stored in the storage unit 12 in advance (Step S403). When the mass of the target object 200 is more than the threshold (YES at Step S403), the alarm display unit 114 causes the display unit 13 to display an alarm message that the target object 200 is heavy (Step S404). On the other hand, when the mass of the target object 200 is less than the threshold stored in the storage unit 12 in advance (NO at Step S403), the alarm display unit 114 does not perform any process of displaying an alarm message. Subsequent operations until performing unclamping (Steps S405 to S411) are identical to operations at Steps S102 to S108 of the first embodiment.

In the present embodiment, when the target object 200 is heavy, an alarm message can be displayed on the display unit 13 before it is unclamped from the clamper 26. Accordingly, an operator can be ready for supporting the target object 200 before unclamping it from the clamper 26. With this configuration, it is possible to prevent a case where an unclamped target object 200 falls from the clamper 26.

Although the present embodiment has described, as an example, a case where the mass of the target object 200 is calculated immediately after it is clamped to the clamper 26, the mass of the target object 200 can be also calculated after performing an unclamping operation (FIG. 7, after Step S401) or it is calculated based on a load current value that is generated while electric discharge machining is performed.

By storing the mass of the target object 200 calculated by the mass calculation unit 117 in the storage unit 13 as historical data, in a case of a failure of the motor 22 or the amplifier 21 due to overweight of the load, it becomes easier to identify the cause of the failure.

Because other features of the present embodiment are identical to those of the first embodiment, redundant explanations thereof will be omitted.

### Fourth Embodiment

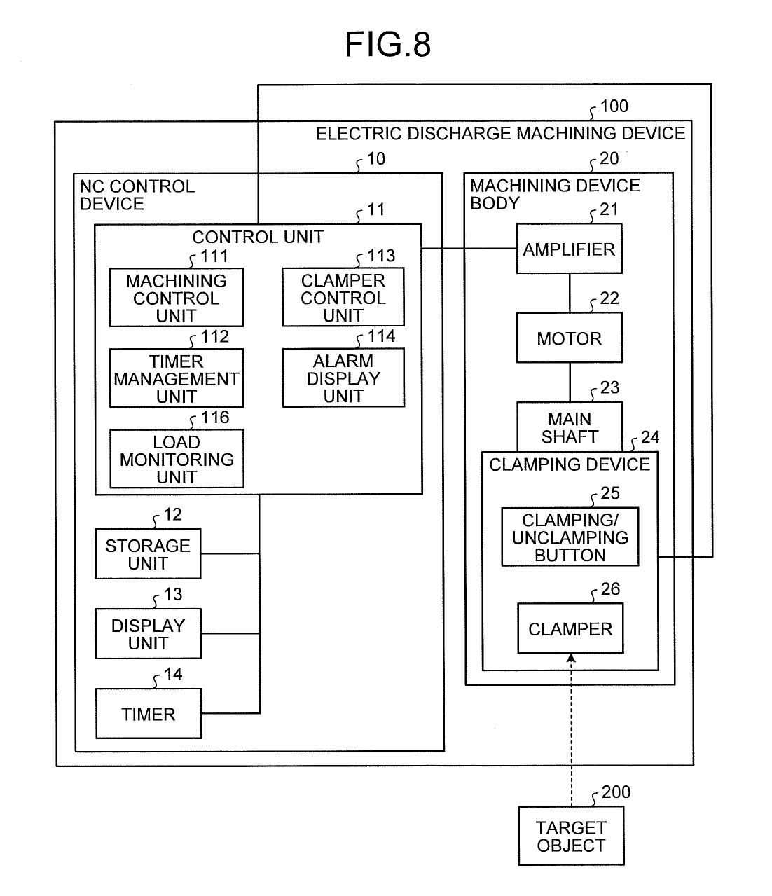

FIG. 8 depicts a configuration of an electric discharge machining device according to a fourth embodiment of the present invention. The fourth embodiment differs from that according to the first embodiment in that the control unit 11 includes the load monitoring unit 116. The load monitoring unit 116 is identical to that according to the third embodiment.

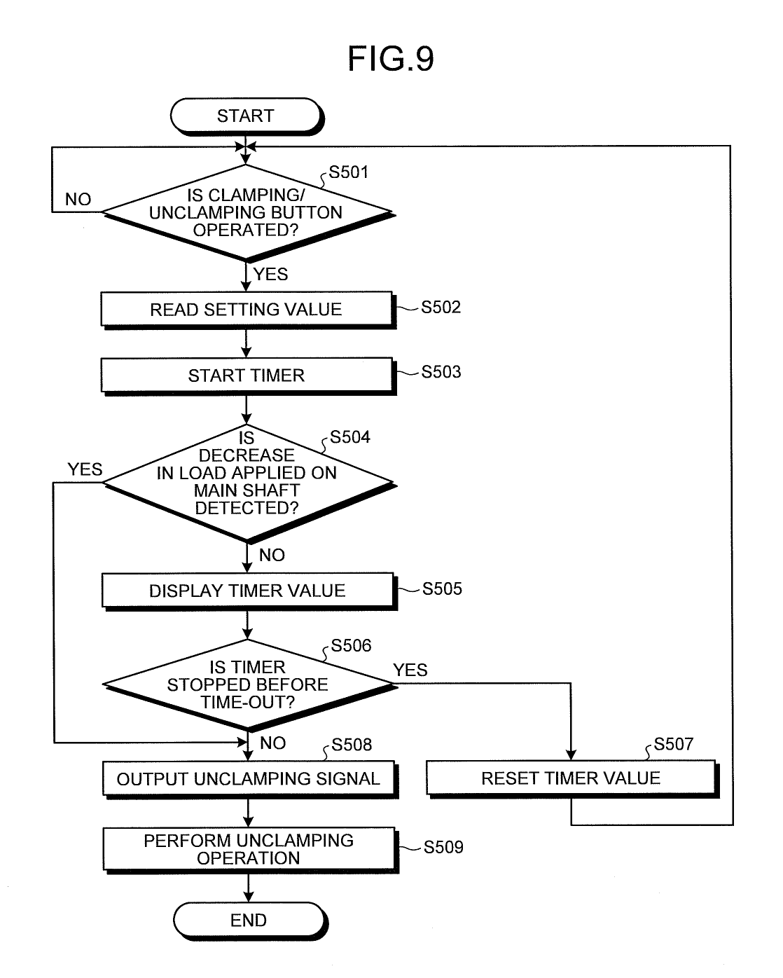

A detaching operation of the target object in the electric discharge machining device according to the present embodiment is explained. FIG. 9 is a flowchart of a flow of an operation at the time of detaching a target object from the electric discharge machining device according to the fourth embodiment. Operations until activating the timer 14 (Steps S501 to S503) are identical to those of the first embodiment. After activating the timer, the load monitoring unit 116 monitors the load of the main shaft 23 (Step S504). Although the main shaft 23 stops at this time, because a standby current is flowing in the amplifier 21 or the motor 22, the load can be monitored as well.

When the load monitoring unit 116 continuously detects a decrease in the load applied on the main shaft 23 for a certain period of time or more during an operation of the timer 14 (YES at Step S504), the clamper control unit 113 outputs an unclamping signal to the clamping device 24 (Step S508) even when time-out of the timer 14 has not occurred and causes the clamper 26 to unclamp the target object 200 (Step S509).

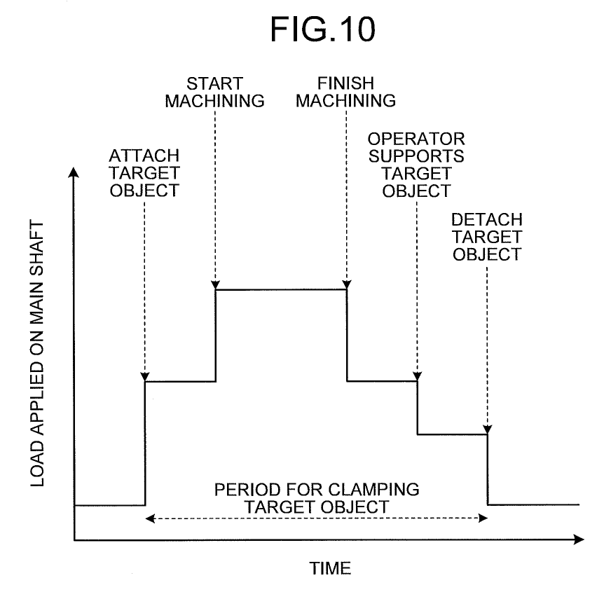

FIG. 10 is a schematic diagram of an example of a change in the load on the main shaft 23. As shown in FIG. 10, when an operator supports the clamped target object 200 from below in order to prevent it from falling from the clamper 26, the load applied on the main shaft 23 decreases. Accordingly, when the load monitoring unit 116 continuously detects a decrease in the load applied on the main shaft 23 for a certain period of time, even after it is unclamped, the target object 200 will not fall down, because it can be considered that the operator supports the target object 200 from below.

When the load monitoring unit 116 does not continuously detect a decrease in the load applied on the main shaft 23 for a certain period of time or more (NO at Step S504), similarly to the first embodiment, the display unit 13 is caused to display a timer value (Step S505) and the timer 14 is monitored whether time-out has occurred (Step S506). When time-out of the timer 14 has occurred (NO at Step S506), the clamper control unit 113 outputs an unclamping signal to the clamping device 24 (Step S508) in order to cause the clamper 26 to unclamp the target object 200 (Step S509). An operator can stop the timer 14 before time-out after starting the timer 14. When the timer 14 is stopped (YES at Step S506), the timer 14 is reset (Step S507) and the process returns to Step S501.

In the present embodiment, at the time of detaching the target object 200, an operator can unclamp it from the clamper 26 at a time point when it is detected that the operator supports the target object 200, based on the load on the main shaft 23. Accordingly, because the operator does not necessarily wait for time-out of the timer 14 while the operator continues to support the target object 200, a time required for replacement thereof can be shortened.

Because other features of the present embodiment are identical to those of the first embodiment, redundant explanations thereof will be omitted.

### Fifth Embodiment

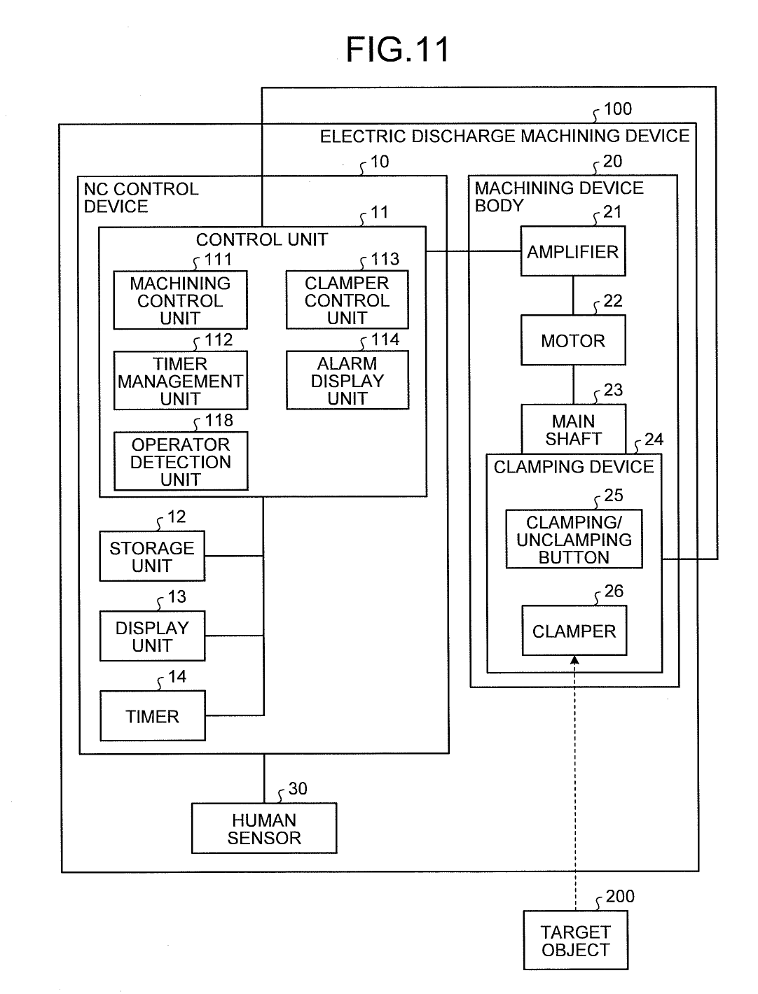

FIG. 11 depicts a configuration of an electric discharge machining device according to a fifth embodiment of the present invention. The fifth embodiment differs from that according to the first embodiment in that the NC control device 10 includes a human sensor 30 and the control unit 11 includes an operator detection unit 118 and the alarm display unit 114.

The human sensor 30 detects that an operator is near the main shaft 23. For example, as the human sensor 30, publicly known technique may be employed, such as an infrared active sensor including a combination of a light emitting unit that emits an infrared ray to the vicinity of the main shaft 23 and a light receiving unit that detects an infrared ray that is reflected by an operator approaching to the main shaft 23 and also detects that the infrared ray is blocked by the operator. Other techniques can be also employed, such as an infrared passive sensor that detects a human body by receiving an infrared ray emitted from the surface of the human body, a light curtain that detects a light blocking object by forming a light wall with a floodlight unit which includes a plurality of light-emitting elements in a line and also with a light receiving unit which includes light-receiving elements having a same number as the light-emitting elements in a line, and a mat switch or a foot pedal, which is arranged near the main shaft 23. The operator detection unit 118 determines whether an operator is present near the main shaft 23 based on an output from the human sensor 30. The alarm display unit 114 causes the display unit 13 to display an alarm message when an operator is not near the main shaft 23.

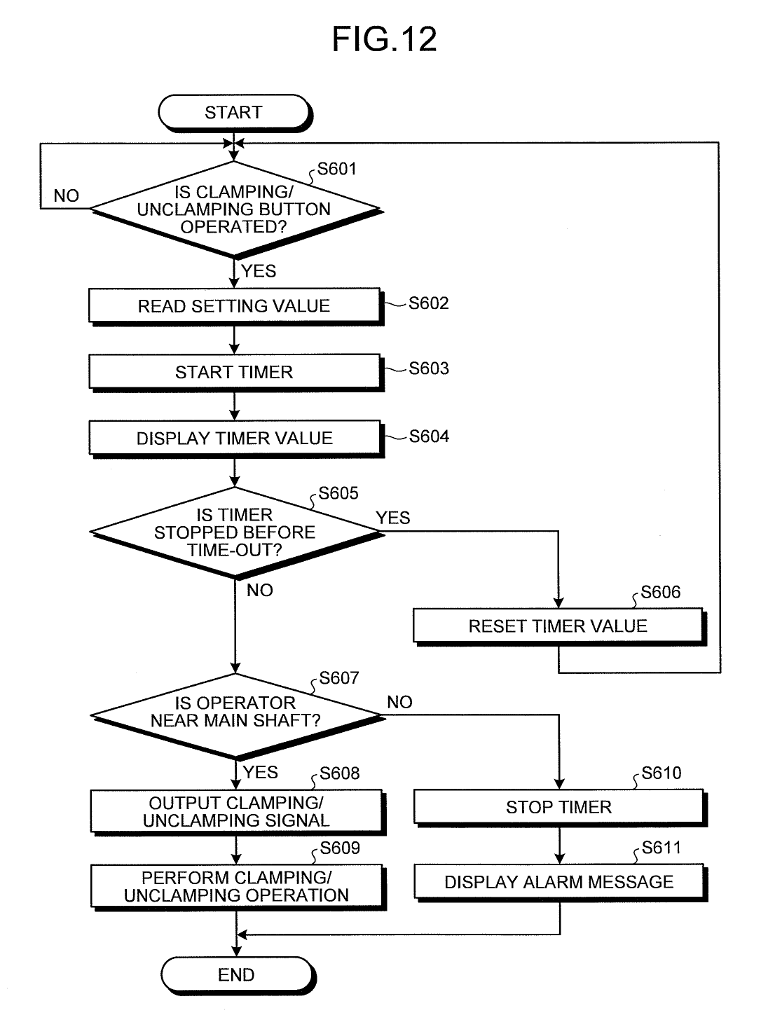

An attaching and detaching operation of a target object in the electric discharge machining device according to the present embodiment is explained. FIG. 12 is a flowchart of a flow of an operation at the time of attaching and detaching a target object in the electric discharge machining device according to the fifth embodiment. Operations until time-out of the timer 14 (Steps S601 to S606) are identical to those at Steps S101 to S106 of the first embodiment. When time-out of the timer 14 occurs (YES at Step S605), the operator detection unit 118 checks whether an operator is present near the main shaft 23 based on a result detected by the human sensor 30 (Step S607). When the human sensor 30 detects that an operator is near the main shaft 23 (YES at Step S607), the clamper control unit 113 outputs a clamping signal or an unclamping signal to the clamping device 24 (Step S608). The clamper 26 clamps or unclamps the target object 200 according to the clamping signal or the unclamping signal (Step S609).

On the other hand, when the human sensor 30 does not detect that an operator is near the main shaft 23 (NO at Step S607), the timer management unit 112 stops the timer 14 (Step S610) and the alarm display unit 114 causes the display unit 13 to display an alarm message (Step S611).

According to the present embodiment, when an operator is not present near the main shaft 23, it can be configured such that a clamping or an unclamping of the target object 200 is not performed. With this configuration, it is possible to prevent a case where the target object 200 is unclamped although an operator is not supporting it or the target object 200 to be clamped is attempted to be clamped although it has not been prepared for it yet.

Because other features of the present embodiment are identical to those of the first embodiment, redundant explanations thereof will be omitted.

In addition, the embodiments described above can be combined.

### INDUSTRIAL APPLICABILITY

As described above, the electric discharge machining device according to the present invention is useful as an invention that can improve the safety in a replacing operation of a target object, by preventing a case where an unclamped target object falls from a clamping device or the target object is caused to be clamped to a clamping device incompletely.

### REFERENCE SIGNS LIST

10 NC control device

11 control unit

12 storage unit

13 display unit

14 timer

20 machining device body

21 amplifier

22 motor

23 main shaft

24 clamping device

25 clamping/unclamping button

26 clamper

27 seating sensor

30 human sensor

100 electric discharge machining device

111 machining control unit

112 timer management unit

113 clamper control unit

114 alarm display unit

115 seating detection unit

116 load monitoring unit

117 mass calculation unit

118 operator detection unit

200 target object

1. An electric discharge machining device that performs electric discharge machining by clamping a target object with a clamping device, the electric discharge machining device comprising:
a timer that counts a lapse of a time, which has been set by a user as a preparation time for supporting the target object after an operation for clamping or unclamping is detected; and
a clamper control unit that causes the clamping device to perform an operation corresponding to the detected operation at a time-out of the timer.

2. The electric discharge machining device according to claim 1, comprising a seating sensor that detects whether the target object is seated in a correct position of the clamping device while the target object is unclamped, wherein
when an operation for clamping the target object has been performed, the clamper control unit causes the clamping device to clamp the target object when the seating sensor detects that the target object is seated in the correct position.

3. The electric discharge machining device according to claim 1, comprising a mass calculation unit that calculates a mass of the target object that is calmped by the clamping device, wherein
when the mass of the target object calculated by the mass calculation unit is more than a predetermined threshold, an alarm is displayed after an operation for unclamping the target object is detected.

4. The electric discharge machining device according to claim 1, comprising a load monitoring unit that detects a load applied on a main shaft on which the clamping device is arranged, wherein
when the load monitoring unit continuously detects a decrease in the load applied on the main shaft for a certain period of time while the target object is clamped, the clamper control unit causes the clamping device to unclamp the target object.

5. The electric discharge machining device according to claim 1, comprising a human sensor that detects a presence of an operator near a main shaft on which the clamping device is arranged, wherein
when the human sensor detects the presence of the operator near the main shaft, the clamper control unit causes the clamping device to perform an operation corresponding to the detected operation.
